(19) United States
(12) Patent Application Publication
(10) Pub. No.: US 2008/0182601 A1
(43) Pub. Date: Jul. 31, 2008

(54) METHOD OF PROCESSING MESSAGE IN MOBILE TERMINAL

(75) Inventor: Mi Hye CHO, Busan Metropolitan City (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/947,456

(22) Filed: Nov. 29, 2007

(30) Foreign Application Priority Data
Jan. 25, 2007 (KR) 10-2007-0007737

(51) Int. Cl. H04Q 7/20

(52) U.S. Cl. 455/466

(57) ABSTRACT

A method of processing a message in a mobile terminal is provided, as well as a method of displaying a message. The method includes displaying a list of stored messages, selecting a plurality of individual messages from the displayed message list, combining the plurality of selected messages into a combined message, and sending the combined message. The method of displaying a message includes receiving a message, determining whether the received message is a combined message including a plurality of individual messages, determining whether a message division display mode is set in the mobile terminal, and displaying the individual messages in divided format if the message division display mode is set in the mobile terminal.

### CROSS REFERENCE TO RELATED APPLICATION

This application claims priority from and the benefit of Korean Patent Application No. 10-2007-0007737, filed on Jan. 25, 2007, which is hereby incorporated by reference for all purposes as if fully set forth herein.

### BACKGROUND OF THE INVENTION

1. Field of the Invention

The present invention relates to a method of processing a message in a mobile terminal, and more particularly, to a method of forwarding a plurality of received messages and receiving and displaying the plurality of forwarded messages.

2. Discussion of the Background

Due to recent development of communication technology, a user can communicate using a mobile terminal while traveling with few limitations due to location. A mobile terminal may provide various functions (for example, message, email, and Internet service), in addition to a voice communication function.

Particularly, message service is a service that can be provided cheaply to a user of the mobile terminal at almost any time and any place and can be used as a communication method. Accordingly, both an older person that may otherwise experience difficulty in using a mobile terminal and a younger person may use message service.

However, when forwarding received messages, a user can send only one message at a time. Accordingly, when a plurality of messages is to be forwarded, a sending process may need to be repeatedly performed according to the number of messages to be forwarded.

### SUMMARY OF THE INVENTION

The present invention provides a method of processing a message in a mobile terminal that may enable easy processing of a message.

The present invention further provides a method of processing a message in a mobile terminal that allows stored messages to be combined and sent.

The present invention further provides a method of processing a message in a mobile terminal that may enable easy editing of a combined message.

Additional features of the invention will be set forth in the description which follows, and in part will be apparent from the description, or may be learned by practice of the invention.

The present invention discloses a method of sending a message in a mobile terminal including displaying a list of stored messages, selecting a plurality of individual messages from the displayed message list, combining the plurality of selected messages into a combined message, and sending the combined message.

The present invention also discloses a method of displaying a message in a mobile terminal. The method includes receiving a message, determining whether the received message is a combined message including a plurality of individual messages, determining whether a message division display mode is set in the mobile terminal, and displaying the individual messages in divided format if the message division display mode is set in the mobile terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal according to an exemplary embodiment of the present invention.

FIG. 2A and FIG. 2B are flowcharts showing a process of sending a message in a method of processing a message in a mobile terminal according to an exemplary embodiment of the present invention.

FIG. 3A is a flowchart showing an operation of editing a message in the process of sending a message of FIG. 2A and FIG. 2B.

FIG. 3B is a flowchart showing an operation of dividing and sending a combined message in the process of sending a message of FIG. 2A and FIG. 2B.

FIG. 4 is a flowchart showing a process of receiving a message in a method of processing a message in a mobile terminal according to an exemplary embodiment of the present invention.

FIG. 5A and FIG. 5B show examples of screens in the process of sending a message of FIG. 2A and FIG. 2B.

FIG. 6 shows examples of screens in the process of receiving a message of FIG. 4.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

In the present invention, ‘message’ is any message containing characters received from another mobile terminal and stored in a mobile terminal, such as a short message, a multimedia message, or an email. For convenience of description, only a short message is described. The message may include a received date/time, sender information, and message content. The sender information may be any of a name, phone number, and email address of a sender.

A ‘combined message’ is a message that includes multiple messages selected by a user and combined into a single message. The combined message includes the received date/time, sender information, and message content of each selected message.

‘Editing the combined message’ refers to editing of a received date/time, sender information, and message content included in the combined message. Editing the combined message may include deleting part of the combined message as well as correcting and adding to the combined message. When a signal requesting deletion is input to the mobile terminal, the mobile terminal deletes at least one item (for example, a received date/time, sender information, or a specific character or phrase included in the message content) in the combined message according to a user request.

When a signal requesting correction and addition is input to the mobile terminal, the mobile terminal generates and displays a cursor on a screen, on which the combined message is displayed, and corrects and adds a received date/time, sender information, or message content according to a user request.

A signal requesting combination of the selected messages is referred to as a ‘signal requesting combination’, and a signal input by the user in order to edit the combined message is referred to as a ‘signal requesting editing’. A signal requesting transmission of the combined message or the edited combined message is referred to as a ‘signal requesting transmission’.

When the mobile terminal receives messages, the mobile terminal determines whether the received messages are messages included in a combined message. A combined message may include individual messages or unit messages, and each unit message may include one or more individual messages. If the received messages are unit messages of a combined message, the mobile terminal combines the unit messages. In this case the unit messages may be combined using division information including a group identifier, which indicates that the unit messages are included in a combined message, and an arrangement order identifier, which indicates the order of the unit messages.

A ‘message division display mode’ indicates a mode in which the controller of a mobile terminal recognizes the start and the end of individual messages included in a received combined message and divides the combined message into the individual messages, which are then displayed.

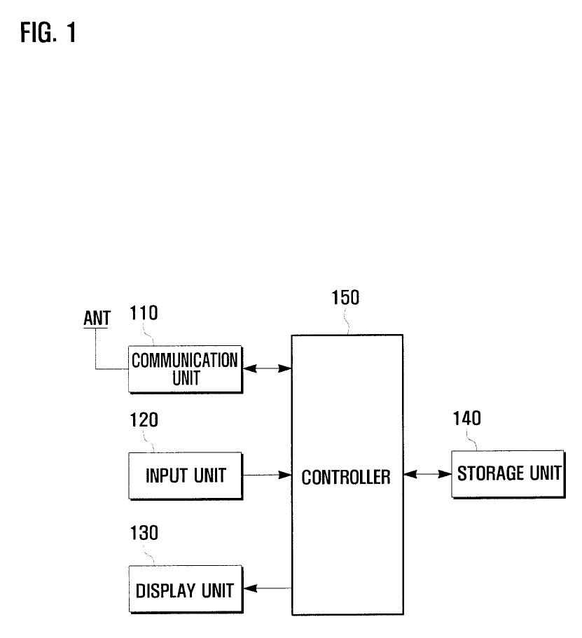

FIG. 1 is a block diagram showing a configuration of a mobile terminal according to an exemplary embodiment of the present invention.

Referring to FIG. 1, the mobile terminal includes a communication unit 110, an input unit 120, a display unit 130, a storage unit 140, and a controller 150.

The communication unit 110 includes a radio frequency (RF) transmitter to up-convert a frequency of a signal to be transmitted and amplify the signal and an RF receiver to down-convert a frequency of a received signal and low-noise amplify the signal. Particularly, the communication unit 110 performs a communication function by sending a message to another mobile terminal or receiving a message from another mobile terminal.

The input unit 120 may include a touch pad or a keypad having various function keys, numeral keys, special keys, and character keys, and outputs an input signal input by a user to the controller 150 to control operation of the mobile terminal. The input unit 120 receives signals selecting a stored message, requesting combination, requesting editing, and requesting transmission from the user and sends the signals to the controller 150.

The display unit 130 may include a liquid crystal display (LCD) and displays various data generated in the mobile terminal and the operating state of the mobile terminal on a screen. Particularly, the display unit 130 may display a list of stored messages, a list of selected messages, a combined message, and a screen for editing the combined message under the control of the controller 150. The display unit 130 displays a key input screen for inputting signals selecting a message, requesting combination, requesting editing, and requesting transmission.

The storage unit 140 stores programs and data required to perform general operations of the mobile terminal. Particularly, the storage unit 140 stores messages received from other mobile terminals.

The controller 150 performs general control operations of the mobile terminal. Particularly, when detecting the input of a signal selecting a message in messages stored in the storage unit 140 and a signal requesting combination, the controller 150 combines the selected messages and displays the content of the combined message on the display unit 130. When a signal requesting editing is received from the input unit 120, the controller 150 controls the display unit 130 to display a screen for editing the combined message.

When a signal requesting deletion is input to the mobile terminal, the controller 150 deletes at least one of a received date/time of a message, sender information included in the combined message, and characters or phrases included in the message content according to a user request.

When a signal requesting correction and addition is input to the mobile terminal, the controller 150 generates a cursor in the screen of the display unit 130 displaying the combined message and corrects and adds to at least one of the received date/time, the sender information, and the message content according to a user request.

When a signal requesting transmission of a combined message, in which editing is complete, is received from the input unit 120, the controller 150 sends the edited combined message using the communication unit 110. In this case, the controller 150 inserts an identifier to indicate that the message is a combined message and flags information regarding the start and the end of the individual messages into the combined message. Then the controller 150 sends the combined message into which the identifier and the flags have been inserted. The flags may include information regarding the start and the end of individual messages included in the combined message.

The controller 150 determines whether the data volume of a combined message to be sent exceeds a critical limit value. If the data volume of the combined message to be sent exceeds a critical limit value, the combined message is divided into unit messages, which are then sent.

A process of dividing a combined message into unit messages is described as follows. In this example, it is assumed that the preset critical limit value of the data volume is 80 bytes and that a combined message A is formed by combining an individual message ‘a’ having a data volume of 40 bytes, an individual message ‘b’ having a data volume of 30 bytes, and an individual message ‘c’ having a data volume of 50 bytes. Individual messages ‘a’, ‘b’, and ‘c’ are combined into the combined message A. However, because the combined message A has a data volume of 120 bytes and exceeds the preset critical limit value (80 bytes) of a data volume, the controller 150 generates a first unit message (volume: 70 bytes) by combining individual message ‘a’ and individual message ‘b’ and separately divides and sends remaining individual message ‘c’ in a second unit message. In this case, the controller 150 additionally inserts a group identifier into each unit message to indicate that the first and second unit messages are divided from the combined message A and an arrangement order identifier to indicate the order of the unit messages within the combined message A. The controller 150 then sends the first and second unit message into which the identifiers are inserted.

The controller 150 determines whether a received message is a combined message by checking whether a combined message identifier is included in the received message. If the received message is a combined message, the controller 150 may differently display the combined message from a normal message when displaying a list of received messages on the display unit 130. If the received messages are unit messages of a combined message, both the group identifiers indicating that the messages are unit messages of the combined message and the arrangement order identifiers indicating the order of the unit messages may be displayed when the content of the unit messages are displayed.

The controller 150 determines whether a message division display mode is set in the mobile terminal. If a message division display mode is set in the mobile terminal, the controller 150 determines the start and the end of the individual messages included in the combined message and divides the combined message into the individual messages and displays each individual message.

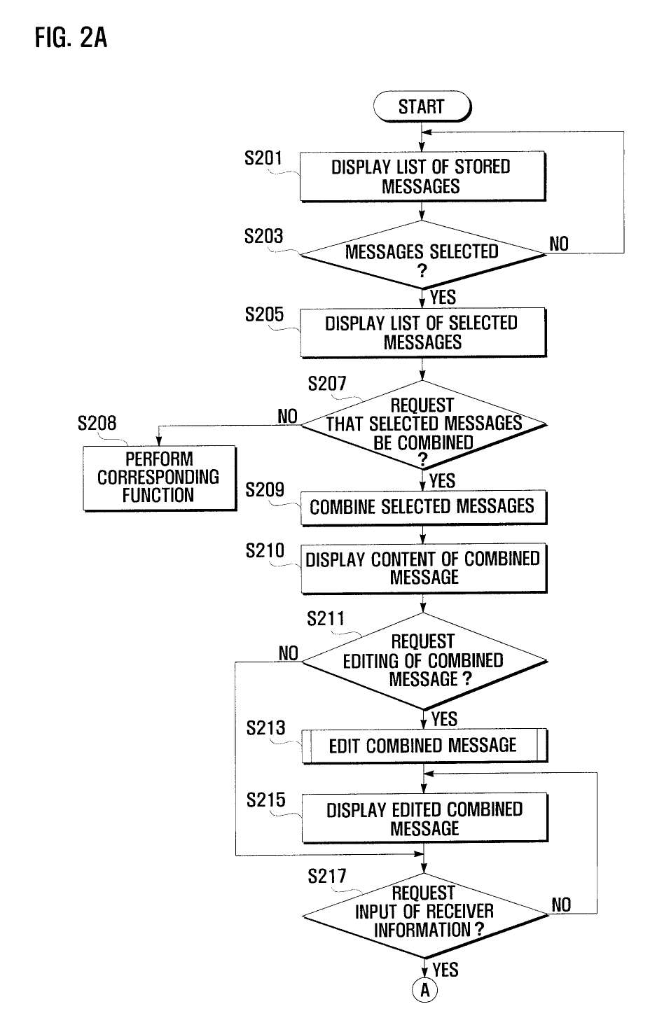

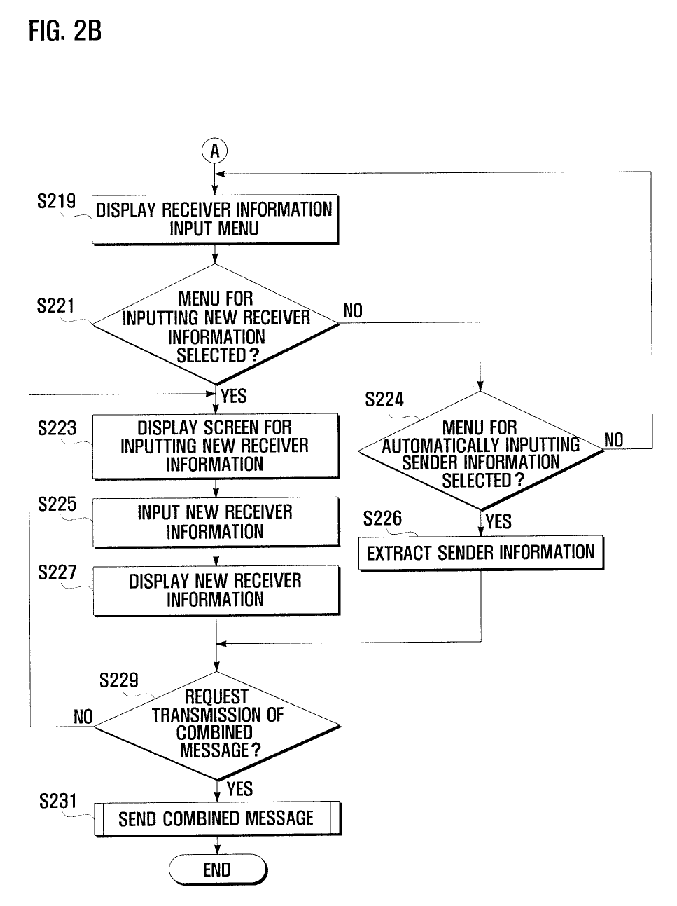

FIG. 2A and FIG. 2B are flowcharts showing a process of sending a message in a method of processing a message in a mobile terminal according to an exemplary embodiment of the present invention.

The controller 150 controls the display unit 130 to display a list of stored messages according to user request (S201).

The controller 150 determines whether a signal selecting messages displayed in a message list is input by the user through the input unit 120 (S203). If a signal selecting messages displayed in a message list is not input by the user through the input unit 120, the process returns to step S201. If a signal selecting messages displayed in a message list is input by the user through the input unit 120, the controller 150 controls the display unit 130 to display a list of the selected messages according to a signal for selecting input messages (S205).

In this case, the controller 150 may distinguish selected messages from unselected messages and differently display a selected message list from an unselected message list on the display unit 130.

The controller 150 determines whether a signal requesting combination of the selected messages is input (S207). If a signal requesting combination of the selected messages is not input, the controller 150 performs a corresponding function (S208). The corresponding function may include deleting the selected messages or setting or releasing protection of the selected messages. If a signal requesting combination of the selected messages is input, the controller 150 combines the selected messages (S209) and controls the display unit 130 to display the content of the combined message (S210).

The controller 150 determines whether a signal requesting editing of the combined message is input (S211). If a signal requesting editing of the combined message is input, the controller 150 edits the combined message (S213) according to a selected editing process.

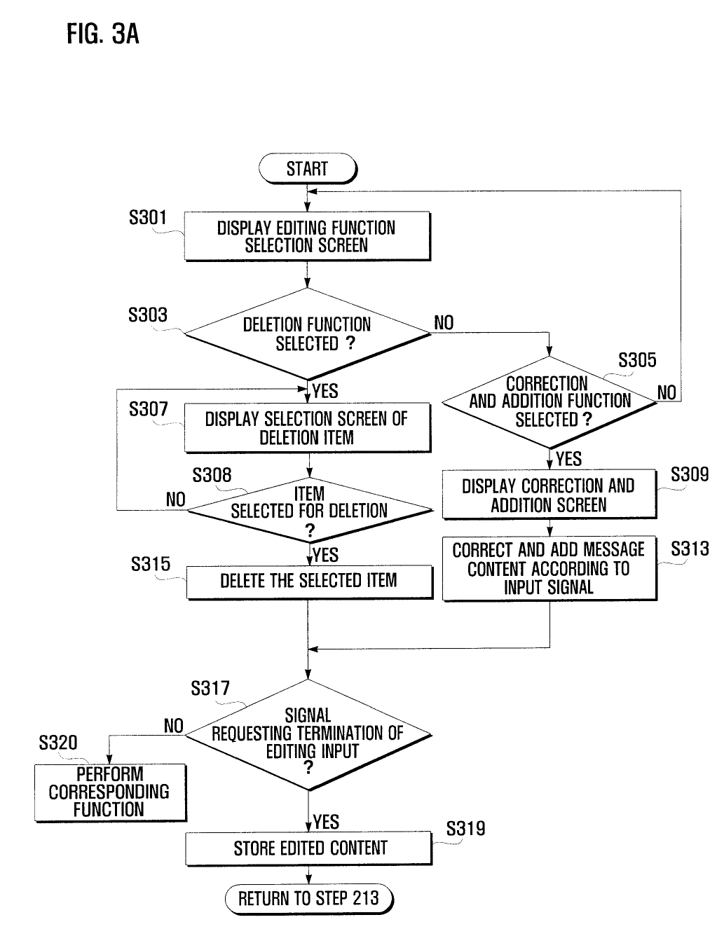

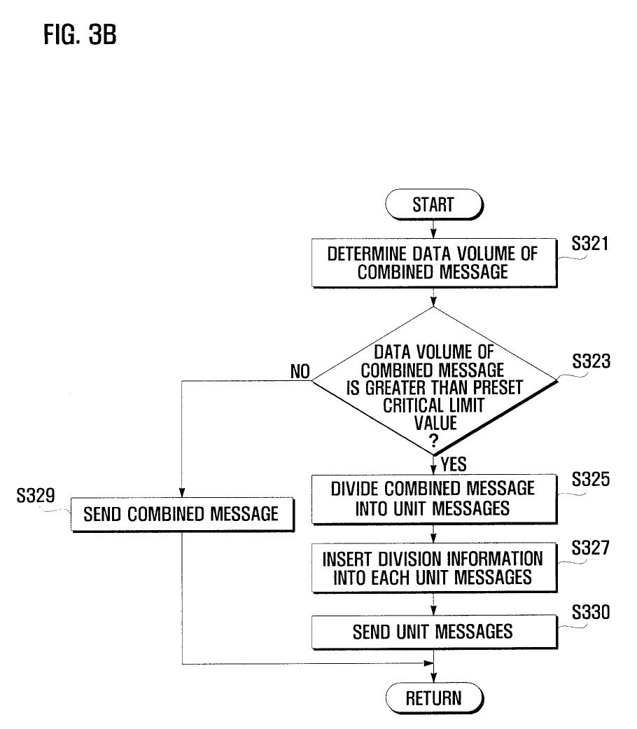

The operation of editing a combined message at step S213 is described below in detail with reference to FIG. 3A.

When the process of editing a message is complete, the controller 150 controls the display unit 130 to display the edited combined message (S215).

While the edited combined image is displayed at step S215, or, if a signal requesting editing of the combined message is not input at step S211 while the unedited combined message is displayed at step S210, the controller 150 determines whether a signal requesting input of receiver information is received (S217). If a signal requesting input of receiver information is not received, the process returns to step S215 and the controller 150 continues to display the edited combined message on the display unit 130 (S215). If a signal requesting input of receiver information is received, the controller 150 controls the display unit 130 to display a receiver information input menu (S219). The receiver information input menu includes selection options of a menu for automatically inputting existing sender information of a message included in the combined message to receiver information and a menu for inputting new receiver information.

The controller 150 determines whether the menu for inputting new receiver information is selected from the displayed receiver information input menu (S221). If the menu for inputting new receiver information is selected, the controller 150 controls the display unit 130 to display a screen for inputting new receiver information (S223).

When new receiver information is input (S225), the controller 150 controls the display unit 130 to display the new receiver information (S227).

If the menu for inputting new receiver information is not selected at step S221, the controller 150 determines whether the menu for automatically inputting existing sender information included in the combined message to the receiver information is selected (S224). If the menu for automatically inputting existing sender information is not selected, the process returns to step S219. If the menu for automatically inputting existing sender information is selected, the controller 150 extracts the sender information included in the combined message (S226).

After extracting the sender information at step S226 or after inputting and displaying the new receiver information at step S227, the controller 150 determines whether a signal requesting transmission of message is input (S229). If a signal requesting transmission of message is input, the controller 150 inserts flags indicating the start and the end of the combined message into the data structure of the combined message and sends the combined message to the corresponding sender or new receiver (S231).

The controller 150 may also insert flags indicating the start and the end of individual messages included in the combined message. The flags indicating the start and the end of the individual messages can be inserted while combining the selected individual messages at step S209.

If the data volume of the combined message exceeds a preset one-time data transmission amount, the controller 150 divides the combined message into unit messages and sends the unit messages at step S231. The one-time transmission data amount of the message may be set by a communication (for example, mobile communication or Internet) service provider. For example, in a general short message service (SMS), Korean mobile communication providers based on code division multiple access (CDMA) set the one-time maximum data transmission amount to 80 bytes, and European mobile communication providers based on a global system for mobile communication (GSM) set the one-time maximum data transmission amount to 140 bytes. Therefore, the one-time data transmission amount may be set to the maximum data volume of the communication service provider of the mobile terminal.

The operation of dividing a combined message into unit messages and sending the unit messages, which is included in the process of sending the combined message at step S231, is described below in detail with reference to FIG. 3B.

FIG. 3A is a flowchart showing the operation of editing a message at step S213 of the process of sending a message of FIG. 2A and FIG. 2B.

If a signal requesting editing of a combined message is input through the input unit 120 (step S211 of FIG. 2A), the controller 150 controls the display unit 130 to display an editing function selection screen (S301).

The editing function includes functions of deletion, correction, and addition of an item selected by the user among items included in the combined message. The items included in the combined message may be a received date/time, sender information, and/or message content included in the combined message.

The controller 150 determines whether a deletion function is selected (S303). If a deletion function is selected, the controller 150 controls the display unit 130 to display an item (for example, a date/time, sender information, and a message content) selection screen so the user can select an item among the items included in the combined message to delete (S307).

The controller 150 determines whether an item for deletion is selected by the user (S308). If an item for deletion is selected, the controller 150 deletes the item in the combined message (S315).

When the item selected for deletion at step S308 is a received date/time and sender information, the controller 150 deletes the received date/time (for example, Nov. 22, 2006, 07:00 PM) and sender information (for example, 01088409129) among the items included in the combined message. When sender information is selected and deleted, it becomes impossible to send the combined message to the contact corresponding to the deleted sender information and it is only possible to send the combined message according to new receiver information.

When message content is selected for deletion by the user at step S308, the controller 150 controls the display unit 130 to display a screen for inputting a specific character or phrase to delete in the combined message. When the user inputs a specific character or phrase, for example, ‘mobile phone’, on the screen for inputting a specific character or phrase and inputs a deletion instruction, the controller 150 deletes the specific character or phrase, i.e. ‘mobile phone’ in the message content of the combined message.

The controller 150 determines whether a signal requesting termination of editing is input (S317). If a signal requesting termination of editing is input, the controller 150 stores an edited content (S319) and returns to step S213 of FIG. 2. If a signal requesting editing termination is not input, the controller 150 performs a corresponding function according to a user request (S320). The corresponding function may include the return to and re-execution of a specific process in the editing process.

If a deletion function is not selected at step S303, the controller 150 determines whether a correction and addition function is selected (S305). If a correction and addition function is not selected, the process returns to step S301. If a correction and addition function is selected, the controller 150 generates a cursor on the editing screen and controls the display unit 130 to display a screen for correcting and adding an item (for example, a received data/time, sender information, or message content) included in the combined message (S309).

The controller 150 corrects and adds message content according to a signal input by the user (S313) and then determines whether a signal requesting termination of editing is input at step S317.

FIG. 3B is a flowchart showing the operation of dividing and sending a combined message at step S231 of the process of sending a message of FIG. 2A and FIG. 2B.

The controller 150 determines the data volume of the combined message to be sent at step S231 of FIG. 2 (S321).

The controller 150 determines whether the data volume of the combined message is greater than a preset critical limit value (S323). The preset critical limit value should not exceed the one-time maximum transmission amount permitted by a communication provider of the mobile terminal.

If the data volume of the combined message does not exceed the preset critical limit value, the controller 150 inserts flags indicating the start and the end of the combined message into the data structure of the combined message and sends the combined message to the input receiver (S329). The controller 150 may also insert flags indicating the start and the end of each individual message included in the combined message. The flags for indicating the start and the end of each individual message of the combined message may be inserted while combining the selected individual messages at step S209 of FIG. 2A.

If the data volume of the combined message exceeds the preset critical limit value at step S323, the controller 150 divides the combined message into unit messages, which each have a size that does not exceed the preset critical limit value (S325). For example, the preset data volume may be 80 bytes and three messages, consisting of individual message ‘a’ (volume: 40 bytes), individual message ‘b’ (volume: 30 bytes), and individual message ‘c’ (volume: 50 bytes), are combined into a combined message A.

The controller 150 can divide the combined message A into a first unit message and a second unit message. The first unit message may be composed of individual message ‘a’ and individual message ‘b’, and the second unit message may be composed of individual message ‘c’.

The controller 150 inserts division information into each of the first unit message and second unit message (S327). The division information includes a group identifier indicating that the first unit message and the second unit message are divided from the combined message A and an arrangement order identifier indicating the order of the first and second unit messages.

The controller 150 also inserts flags indicating the start and the end of each individual message into the data structure of each unit message and sends each unit message to the input receiver (S330).

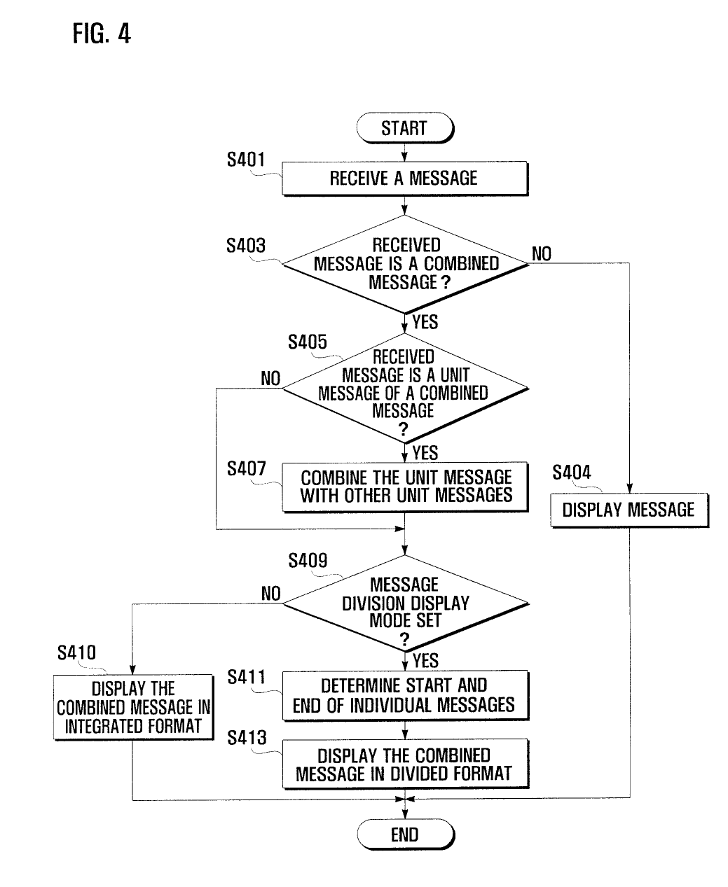

FIG. 4 is a flowchart showing a process of receiving a message in a method of processing a message in a mobile terminal according to an exemplary embodiment of the present invention.

When a message is received (S401), the controller 150 determines whether the received message is a combined message (S403). This is determined by recognizing whether a combined message identifier is inserted into a data structure of the message. If the received message is not a combined message but a normal message, the controller 150 displays the message (S404).

If the received message is a combined message, the controller 150 then determines whether the message is a unit message of a combined message by checking for a combined group identifier and an arrangement order identifier in the data structure of the message (S405).

If the message is a unit message of a combined message, the controller 150 combines the unit message with other unit message(s) of the corresponding combined message (S407). In this case, the controller 150 can sequentially combine the unit messages with reference to the combined group identifier and the arrangement order identifier included in the data structure of each unit message.

The controller 150 determines whether a message division display mode for dividing and displaying individual messages constituting a combined message is set in the mobile terminal (S409). If a message division display mode is set in the mobile terminal, the controller 150 determines the start and the end of individual messages using flags included in the data structure of the combined message (S411).

The controller 150 divides the received combined message into the individual messages according to the flags and controls the display unit 130 to display the individual messages in a divided format (S413).

If a message division display mode is not set in the mobile terminal at step S409, the controller 150 controls the display unit 130 to display the individual messages constituting the combined message in an integrated format, without separating the individual messages (S410).

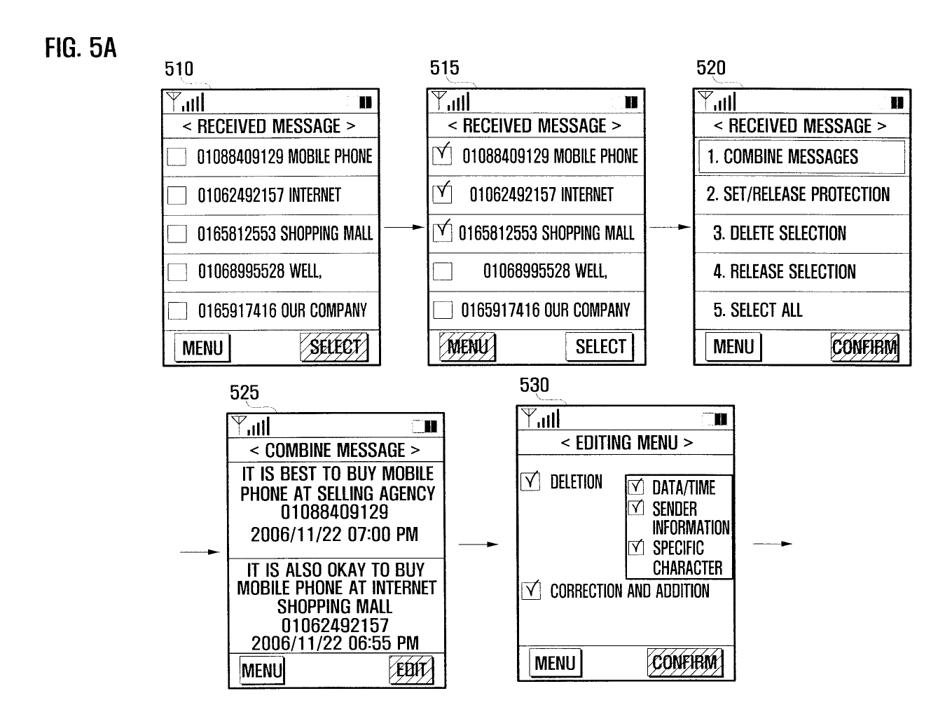

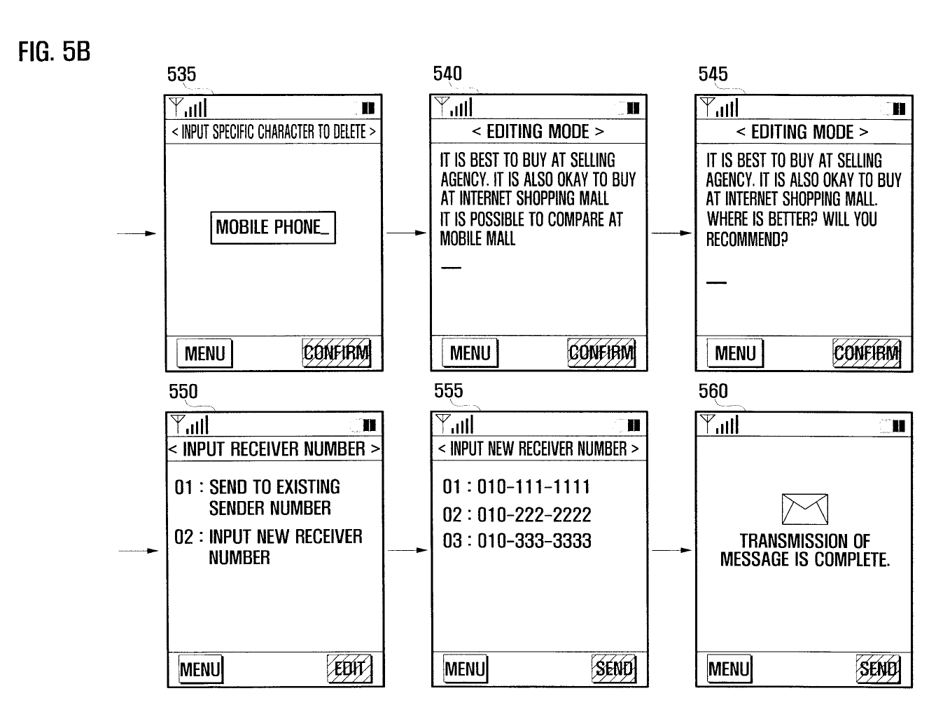

FIG. 5A and FIG. 5B show examples of screens in the process of sending a message of FIG. 2A and FIG. 2B.

The controller 150 controls the display unit 130 to display a list of stored messages in the display unit 130 according to a user request, as shown in screen example 510. If a signal selecting a message is input by the user, the controller 150 distinguishes the list of stored messages between a list of selected messages and a list of unselected messages and controls the display unit 130 to display the lists, as shown in screen example 515.

If a signal requesting combination of the selected messages is input (for example, by selecting ‘1. Combine messages’ and inputting ‘Confirm’), as shown in screen example 520, the controller 150 combines the selected messages, as shown in a screen example 515, and controls the display unit 130 to display contents of the combined selected messages, as shown in screen example 525.

If a signal requesting editing is input (for example, by inputting ‘Edit’ in the screen example 525), the controller 150 controls the display unit 130 to display a screen for selecting a deletion function and a correction and addition function, as shown in a screen example 530. If the user selects the deletion function, the controller 150 controls the display unit 130 to display a screen for selecting an item (for example, a date/time, sender information, or a specific character included in the message content) for deletion, as shown in screen example 530.

If the user selects ‘date/time’ and ‘sender information’ for deletion, the controller 150 deletes all ‘date/time’ information and ‘sender information’ included in the combined message, as shown in screen example 540.

If the user selects ‘specific character’ for deletion, the controller 150 controls the display unit 130 to display a window for inputting a specific character or phrase to delete in the display unit 130, as shown in screen example 535. In screen example 535, the user inputs a specific character or phrase (for example, ‘mobile phone’) and the controller 150 deletes all occurrences of ‘mobile phone’ in the message content of the combined message, as shown in screen example 540.

If the user selects the correction and addition function, as shown in screen example 530, the controller 150 generates a cursor and displays the cursor on an editing screen of the combined message, as shown in screen example 540. The user may additionally input a message such as ‘Where is better? Will you recommend?’ using the cursor, as shown in screen example 545.

If a signal requesting input of receiver information is input by the user (for example, by inputting a confirmation key), the controller 150 controls the display unit 130 to display a receiver information input menu, as shown in screen example 550. The receiver information input menu includes a menu option for inputting existing sender information included in the combined message as the receiver information and a menu option for inputting new receiver information. If the user selects the menu option for inputting new receiver information, the controller 150 controls the display unit 130 to display a screen for inputting new receiver information, as shown in screen example 555. Thereafter, if a signal requesting transmission of a message is input by the user, the controller 150 sends the combined message to the receiver. The controller 150 determines the data volume of the combined message and divides, if the data volume exceeds the preset critical limit value, the combined message into unit messages, which each have a data volume less than or equal to the critical limit value, and sends the unit messages sequentially.

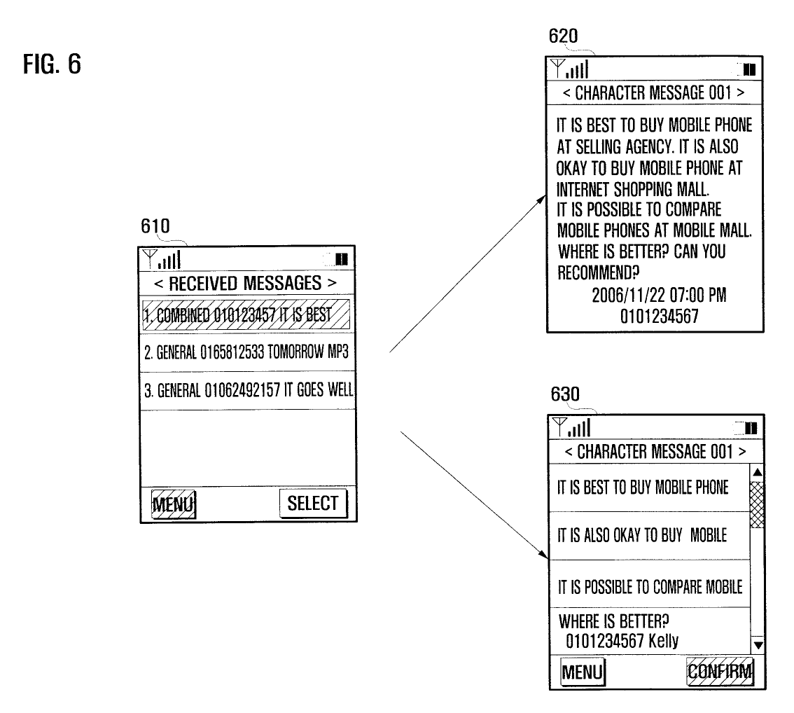

FIG. 6 shows examples of screens in the process of receiving a message of FIG. 4.

Referring to FIG. 1 and FIG. 6, the messages stored in the mobile terminal may be classified as combined messages or general messages and the classified messages may be displayed when the mobile terminal is in a received message display mode, as in screen example 610. If, for example, the user receives a message from a phone number ‘0101234567’, the controller 150 determines whether the received message is a unit message of a combined message.

If the received message is a unit message of a combined message, the controller 150 sequentially combines the unit message with other unit message(s) of the corresponding combined message with reference to group identifier indicating the unit messages are divided from a same combined message. Thereafter, the controller 150 determines whether a message division display mode is set in the mobile terminal. If a message division display mode is set in the mobile terminal, the controller 150 divides the combined message according to the start and the end of the individual messages, as in screen example 630. If a message division display mode is not set in the mobile terminal, the controller 120 displays the combined message as one message without separating the individual messages, as in screen example 620.

As described above, according to exemplary embodiments of the present invention, a message may be easily processed. Further, messages to send can be combined. Further still, a combined message can be easily edited.

It will be apparent to those skilled in the art that various modifications and variations can be made in the present invention without departing form the spirit or scope of the invention. Thus, it is intended that the present invention cover the modifications and variations of this invention provided they come within the scope of the appended claims and their equivalents.

What is claimed is:

1. A method of sending a message in a mobile terminal, comprising:
displaying a list of stored messages;
selecting a plurality of individual messages from the displayed message list;
combining the plurality of selected messages into a combined message; and
sending the combined message.

2. The method of claim 1, further comprising editing the combined message after combining the plurality of selected messages into the combined message.

3. The method of claim 1, wherein the stored messages comprise a short message, a multimedia message, or an email.

4. The method of claim 1, wherein the combined message comprises flags indicating the start and the end of the selected messages in the combined message.

5. The method of claim 1, wherein the combined message comprises an identifier indicating that it is a combined message.

6. The method of claim 1, further comprising inputting receiver information before sending the combined message.

7. The method of claim 6, wherein the receiver information comprises a phone number and an email address.

8. The method of claim 1, wherein the selected messages are displayed differently from unselected messages.

9. The method of claim 1, wherein sending the combined message comprises:
determining whether a data volume of the combined message exceeds a critical limit value;
dividing the combined message into a plurality of unit messages if the data volume of the combined message exceeds the critical limit value; and
sending the unit messages including division information.

10. The method of claim 9, wherein the the combined message comprises a combined message identifier indicating that it a combined message, flags indicating the start and the end of the combined message, and flags indicating the start and the end of an individual message contained in the combined message.

11. The method of claim 9, wherein the division information comprises a group identifier indicating that the unit message is divided from the combined message and an arrangement order identifier indicating an order of the unit message in the combined message.

12. A method of displaying a message in a mobile terminal, comprising:
receiving a message;
determining whether the received message is a combined message including a plurality of individual messages;
determining whether a message division display mode is set in the mobile terminal if the received message is the combined message; and
displaying the individual messages in divided format if the message division display mode is set in the mobile terminal.

13. The method of claim 12, further comprising:
determining whether the received message is a unit message of a combined message before determining whether the message division display mode is set in the mobile terminal; and
combining the unit message with unit messages of the corresponding combined message if the message is a unit message of a combined message.

14. The method of claim 13, wherein combining the unit message comprises:
checking division information contained in each unit message of the corresponding combined message; and
combining the unit messages in order according to the division information.

15. The method of claim 14, wherein the division information comprises a group identifier indicating that the unit message is divided from the combined message and an arrangement order identifier indicating an order of the unit message.

16. The method of claim 12, wherein displaying the individual messages in divided format comprises:
checking flags indicating the start and the end of the individual messages contained in the data structure of the message; and
displaying the individual messages included in the combined message according to the determined flags.

17. The method of claim 12, further comprising:
displaying the individual messages in an integrated format if the message division display mode is not set in the mobile terminal.
